(19) United States
(12) Patent Application Publication
(10) Pub. No.: US 2016/0339823 A1
(43) Pub. Date: Nov. 24, 2016

(54) SUSPENSION FOR A MULTIPLE HEIGHT VEHICLE

(71) Applicant: Dallas Smith Corp., Greencastle, IN (US)

(72) Inventors: Judson L. Smith, Greencastle, IN (US); Virgil R. Dutton, Ft. McDowell, AZ (US)

(73) Assignee: Dallas Smith Corp., Greencastle, IN (US)

(21) Appl. No.: 15/225,235

(22) Filed: Aug. 1, 2016

Related U.S. Application Data
(63) Continuation-in-part of application No. 14/575,453, filed on Dec. 18, 2014.
(60) Provisional application No. 62/199,722, filed on Jul. 31, 2015.
(60) Provisional application No. 62/081,917, filed on Nov. 19, 2014.
(60) Provisional application No. 62/052,197, filed on Sep. 18, 2014.
(60) Provisional application No. 62/019,720, filed on Jul. 1, 2014.
(60) Provisional application No. 61/940,012, filed on Feb. 14, 2014.
(60) Provisional application No. 61/917,627, filed on Dec. 18, 2013.

(51) Int. Cl. B60P 1/18; B60P 1/02; B60P 1/44; B60G 17/027

(52) U.S. Cl. CPC B60P 1/18; B60G 17/0275; B60P 1/027; B60P 1/4471; B60G 2300/024

(57) ABSTRACT

This disclosure relates to rear drive axle suspension systems for OEM cargo truck and ambulance type vehicles and more particularly to a method and a means to provide said vehicles with a Two-Position suspension system, wherein Position-1 is for vehicle transport and Position-2 is for vehicle loading and unloading.

### CROSS-REFERENCE TO RELATED APPLICATIONS

This application is a continuation-in-part of U.S. application Ser. No. 14/575,453, filed Dec. 18, 2014; application Ser. No. 14/575,453 claims the benefit of priority to U.S. provisional patent application Ser. No. 62/081,917, filed Nov. 19, 2014; U.S. provisional patent application Ser. No. 62/052,197, filed Sep. 18, 2014; U.S. provisional patent application Ser. No. 62/019,720, filed Jul. 1, 2014; U.S. provisional patent application Ser. No. 61/940,012, filed Feb. 14, 2014; and U.S. provisional patent application Ser. No. 61/917,627, filed Dec. 18, 2013; this application claims the benefit of provisional patent application Ser. No. 62/199,722, filed Jul. 31, 2015, all of which are incorporated herein by reference.

### FIELD OF THE INVENTION

This disclosure relates generally to vehicle suspensions and in particular to suspensions for cargo-carrying vehicles, including suspensions and suspension kits useful in reducing the height of the cargo floor.

### BACKGROUND

Typically, original equipment manufacturer (OEM) leaf spring rear shackles consist of an upper pivot bushing and a lower pivot bushing that are rigidly connected together. Both the upper and lower pivot bushings are typically made of rubber and have the general purpose of providing limited pivoting travel in the shackle (fore and aft) to help dampen wheel bounce events.

It is well described within the art that standard OEM truck rear drive axles generally incorporate leaf spring type suspension systems as can be seen in patents: U.S. Pat. No. 2,226,047; U.S. Pat. No. 3,213,959; U.S. Pat. No. 2,919,760; and, U.S. Pat. No. 3,213,959. Coil rear drive axle springs have also been used by OEMs, but generally have such applications with vehicles having a low gross vehicle axle rating (automobiles), as can be seen in patent U.S. Pat. No. 2,300,844.

Although leaf spring type suspensions generally provide adequate jounce and rebound of the vehicle's axle travel, they are operated in only a single position, which is at the vehicle's ride height. To provide lowering of the truck's rear load floor, e.g. for a do it yourself self-moving van truck having a loading/unloading ramp, the OEM leaf spring suspension is normally replaced with an air suspension system such as a Kelderman brand F2R24ECC11AL (U.S. Pat. No. 6,340,165) or, a Link brand 8M000097 or, a Liquid Air, Granning, and Hendrickson brands of air suspension systems. Replacing an OEM leaf spring suspension with an air ride suspension can be time consuming and normally at additional significant cost. Still other designs have been offered for manipulation of one or more leaf springs, including U.S. Pat. No. 5,433,578.

Furthermore, OEM trucks generally have frame rails with an overall width of approximately 34 inches—which places the centerline of the leaf spring, or an air suspension “spring base,” at approximately 40 inches. Ambulance type vehicles encounter emergency type driving requirements that include excessive vehicle speeds, maneuverings, braking, etc. It would be desirable in such vehicle use applications to have a rear suspension with a wider “spring base” to provide improved vehicle ride, stability, handling, and safety. Also, ambulance type vehicles often meet a specific vehicle rear load floor deck height dimension for “standard” patient gurney height access, which in most cases necessitates the lowering of certain vehicle's rear load floor during the time patient gurneys are removed from or placed into the ambulance.

These features are important components of trucks with respect to the operating characteristics, original costs and maintenance of such vehicles. Accordingly, it is desirable to provide such rear axle suspensions that have optimum operating characteristics combined with improved safety, driver comfort, and the added utility of being able to change the rear suspension's relationship with the vehicle's frame in order to enhance a truck's loading and unloading operations.

Heretofore, rear axle suspensions for trucks have been available whereby the active suspension members, e.g., air springs, leaf springs, coil springs, etc., are positioned in close proximity to the truck's frame rails, and generally adjacent to the centerline of the rear drive axle, which provides for a narrow spring base with very little active leverage of the suspension in the axle's jounce and rebound travel.

However, rear axle leaf suspensions have not been previously known or available which provide both a ride height position combined with a lowered height position. And, a method or means to provide a wider leveraged spring base with a means to also lower the truck's load floor. Such novel combinations of a two position leaf spring suspension, and or a wider leveraged rear suspension spring base of the truck's load floor are described below.

### SUMMARY

It would be desirable to be able to lower and/or raise a standard leaf spring rear axle suspension of an OEM truck's load floor to achieve: alignment with warehouse unloading dock heights; lowering, for trucks utilizing pull-out loading ramps wherein having a lower load floor of a truck will require a shorter overall length ramp; and, whereby with certain cargo of a truck that is loaded and unloaded by stepping-in and stepping-out from the lowered load floor becomes an easier and safer operation.

### BRIEF DESCRIPTION OF THE DRAWINGS

FIG. 1 is a rear view of OEM chassis cab vehicle having a leaf spring rear suspension.

FIG. 2 is a rear view of the chassis cab vehicle of FIG. 1 with a retractor mechanism to compress the leaf spring suspension to lower the rear frame deck of the vehicle.

FIG. 3 is a rear view of the chassis cab vehicle of FIG. 1 with rear frame deck lowered (compressed suspension).

FIG. 4 is a side elevation view of a chassis cab vehicle at ride height with a rear trailing arm coil suspension, according to another embodiment.

FIG. 5 is a side elevation view of the chassis cab vehicle of FIG. 4 at lowered (compressed) height with a rear trailing arm coil suspension.

FIG. 6 is a rear view of the chassis cab vehicle of FIG. 4 at ride height having a trailing arm coil spring suspension and mechanism to compress suspension to lower vehicle's rear deck frame.

FIG. 7 is a rear view of the chassis cab vehicle of FIG. 4 at lowered (compressed coil suspension) rear deck frame.

FIG. 8 is an isometric view of the chassis cab vehicle of FIG. 4 having a trailing arm coil suspension.

FIG. 9 is a perspective view of a portion of a chassis from the right front looking aft, with the front suspension shown at the normal ride height.

FIG. 10 is a close up of a portion of the apparatus of FIG. 9 from the same perspective.

FIG. 11 is a close up of a portion of the apparatus of FIG. 10 from the same perspective.

FIG. 12 is a perspective view of the apparatus of FIG. 9 as shown from the right looking forward.

FIG. 13 is a view of the apparatus of FIG. 12, from a lower viewing angle.

FIG. 14 is a view of the apparatus of FIG. 13, with the front suspension shown at a lowered height.

FIG. 15 is a close up of the apparatus of FIG. 14.

FIG. 16 is a close up of the apparatus of FIG. 14, from a front perspective looking aft.

FIG. 17 is a perspective view of a portion of a chassis according to another embodiment, from the left side looking inboard, with a left front suspension shown at a normal ride height.

FIG. 18 is a view of the apparatus of FIG. 17, at a lowered position.

FIG. 19 is a side elevational view of a portion of a suspension according to yet another embodiment shown at a ride height.

FIG. 20 is a side elevational view of the apparatus of FIG. 19 at a lowered height.

FIG. 21 is an end view looking forward of a rear suspension according to yet another embodiment shown at a ride height.

FIG. 22 is a view from above of the apparatus of FIG. 21.

FIG. 23 is a view of the apparatus of FIG. 21, with the chassis placed at a lowered height.

FIG. 24 is a front-side perspective view of yet another embodiment of a kneeling system mounted on a vehicle frame.

FIG. 25 is a rear-side perspective view of the FIG. 24 system.

FIG. 26 is a side elevational view of the FIG. 24 system.

FIG. 27 is a side elevational view including partial cross sections of the FIG. 24 system as shown in FIG. 26.

FIG. 28 is a rear elevational view of the FIG. 24 system.

### DETAILED DESCRIPTION OF THE DRAWINGS

While the claimed invention may be embodied in many different forms, for the purpose of promoting an understanding of the principles of the claimed invention, reference will now be made to the embodiments illustrated in the drawings, and specific language will be used to describe the same. It will nevertheless be understood that no limitation of the scope of the claimed invention is thereby intended. Any alterations and further modifications in the described embodiments and any further applications of the disclosed principles as described herein are contemplated as would normally occur to one skilled in the art to which the claimed invention relates.

Some of the figures shown herein may include dimensions. Further, some of the figures shown herein may have been created from scaled drawings or from photographs that are scalable. It is understood that such dimensions, or the relative scaling within a figure, are by way of example, and not to be construed as limiting.

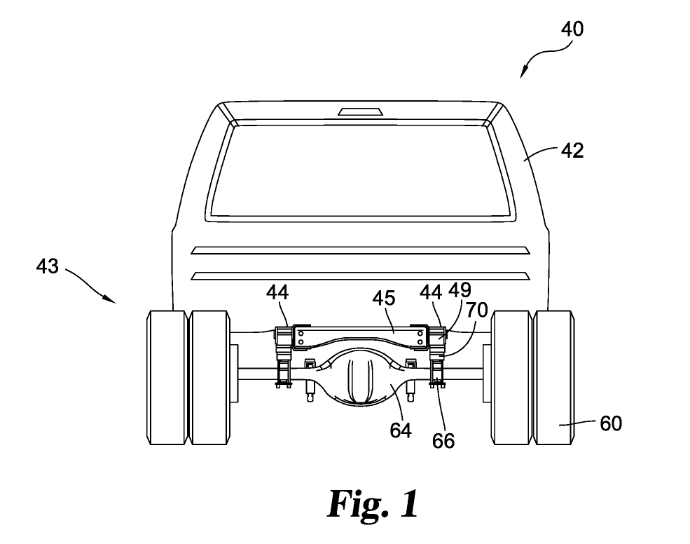

A first embodiment is shown in FIGS. 1-3, which illustrate an OEM chassis cab truck vehicle 40 with a leaf spring suspension having a gear/axle housing 64 that is indirectly connected to an actuator 80 through link 90 that is attached to axle housing 64 by bracket 69. In the illustrated embodiment, actuator 80 provides a rotational response force to link 90 after receiving power, including as examples electric, hydraulic, and pneumatic motors. The actuator is attached to the vehicle's frame 45 and the connection between the rear axle bracket and the actuator is through a flexible link such as a chain. In some embodiments, actuator 80 includes a sprocket having a plurality of teeth, wherein each of the teeth couple to a link of the chain. In yet other embodiments, retracting link 90 can be a toothed belt, with actuator 80 likewise having each tooth or cog of the belt aligning in a toothed or cogged pulley. In still further embodiments, link 90 can be a cable that attaches at one end to a linear actuator, and at the other end to bracket 69, such that retraction of the linear actuator applies tension to the cable link.

Upon receiving an electronic signal from an electronic controller, or a manual signal (such as by an operator pressing a button) the actuator causes the leaf spring suspension to compress, by winding link 90 about a rotating surface of actuator 80 so as to pull frame 43 and gear/axle housing 64 together. In some embodiments the actuator 80 may be of a type that substantially locks in the absence of a control signal, such that the position of frame 43 is maintained after the vehicle is brought to the compressed height. As examples, this locking can be accomplished by maintaining hydraulic pressure or electrical power sufficient to maintain actuator 80 in position. As yet other examples, a solenoid-operated pin could be inserted through a corresponding hole in actuator 80 or link 90 so as to provide a positive mechanical stop preventing extension of link 90.

For reference, FIG. 1 illustrates a ride height while FIG. 3 illustrates a lowered height. After the operator is finished with using the vehicle at the lowered height, a corresponding electronic signal or manual signal (such as by pressing a button, or by removing a mechanical lock) releases the position of the rotary or linear actuator, such that the stored energy of the compressed leaf spring is released to cause the frame 43 to return to its normal ride height. The features shown in the above-described embodiment provide a leaf spring suspension, which can be lowered to adjust the height of a load floor of the vehicle to align with loading/unloading docks, reduce the required step up height to the load floor or to provide a sloping floor for easier unloading and loading of cargo by two wheeled carts and the like.

FIG. 1 is a rear view drawing of vehicle 40 which includes cab 42. Vehicle 40 includes vehicle frame 43 that is generally defined by longitudinal frame rails 44 connected by laterally spaced cross members 45 creating a load floor. Vehicle 40 also includes wheel support 62 that generally includes axle housing 64 that supports wheels 60. In the illustrated embodiment, axle housing 64 supports a plurality of wheels. In alternative embodiments, axle housing 64 could support a single wheel. Vehicle frame 43 is suspended above the wheel support by spring 70. In the illustrated embodiment, springs 70 are conventional leaf springs. Springs 70 are coupled to axle housing 64 by lower mounts 66. Springs 70 are coupled to vehicle frame 43 by upper mounts 49. As illustrated, upper mounts 49 couple spring 70 directly to outboard faces of frame rails 44.

Springs 70 are a conventional leaf spring suspension for vehicle 40. Upon the vehicle's wheel 60 jounce and/or rebound action, spring 70 can compress (jounce) or decompress (rebound), e.g., during a vehicle's travel over a bumpy, irregular surfaced road. Spring 70 permits vehicle frame 43 to move relative to wheel support 62 to minimize the movement of vehicle frame 43 when vehicle 40 travels over irregular surfaces.

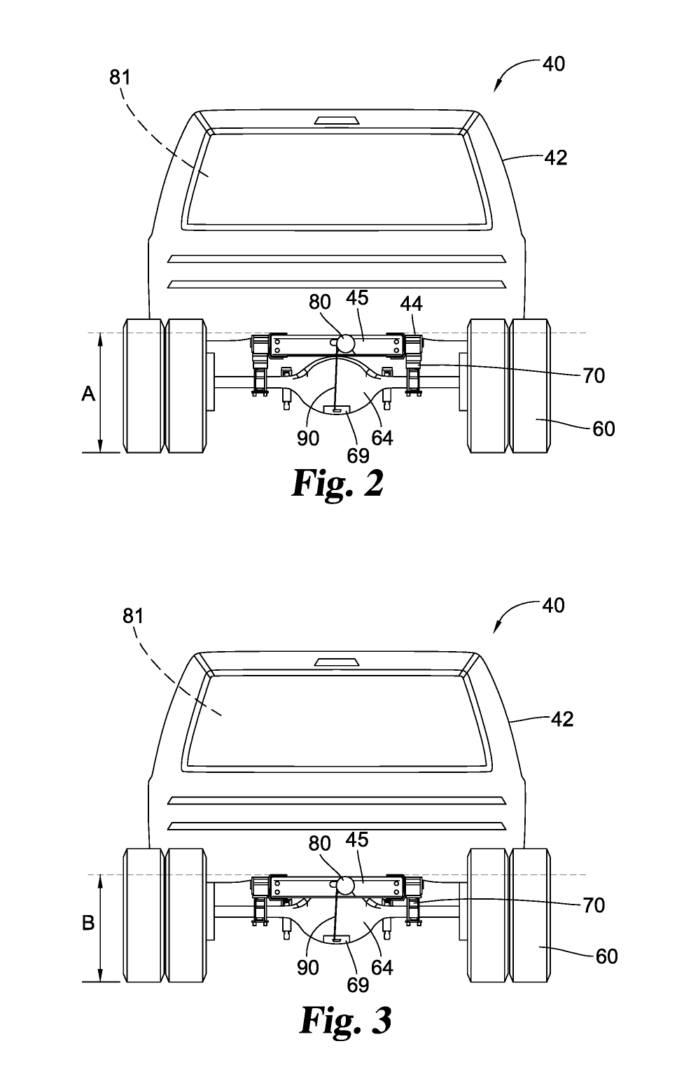

Now referring to FIG. 2, actuator 80 and link 90 are shown coupling frame 43 to wheel support 62. Actuator 80 is attached to cross member 45 of frame 43. Link 90 is attached to bracket 69 that is attached to axle housing 64. In the illustrated embodiment, link 90 is a flexible connector such as a chain or cable and actuator 80 is a rotary actuator that includes a spool or a sprocket or other structure to receive a length of link 90 such that actuator 80 can effectively vary the distance between actuator 80 and bracket 69. Actuating actuator 80 causes link 90 to either retract or deploy from actuator 80. As shown in FIG. 3, actuator 80, upon receiving a command signal, rotates in a direction which retracts link 90 thereby compresses spring 70 and lowering the vehicle's rear load floor represented by the vehicle's frame 43 relative to wheels 60. Actuator controller 81 may optionally be located in cab 42 to permit an operator to control actuator 80 without leaving cab 42. In other embodiments, actuator controller 81 may be located outside of cab 42 but spaced apart from actuator 80 to permit remote control of actuator 80.

FIG. 2 illustrates frame 43 in a ride height position, i.e., a base position of frame 43 relative to wheel support 62. Distance A the distance between the top of frame 43 and the ground in the ride height position. FIG. 3 illustrates a lowered height where springs 70 are compressed and frame 43 is positioned closer to wheels 60. Distance B is the distance between the top of frame 43 and the ground in a lowered height position. Distance A is greater than distance B.

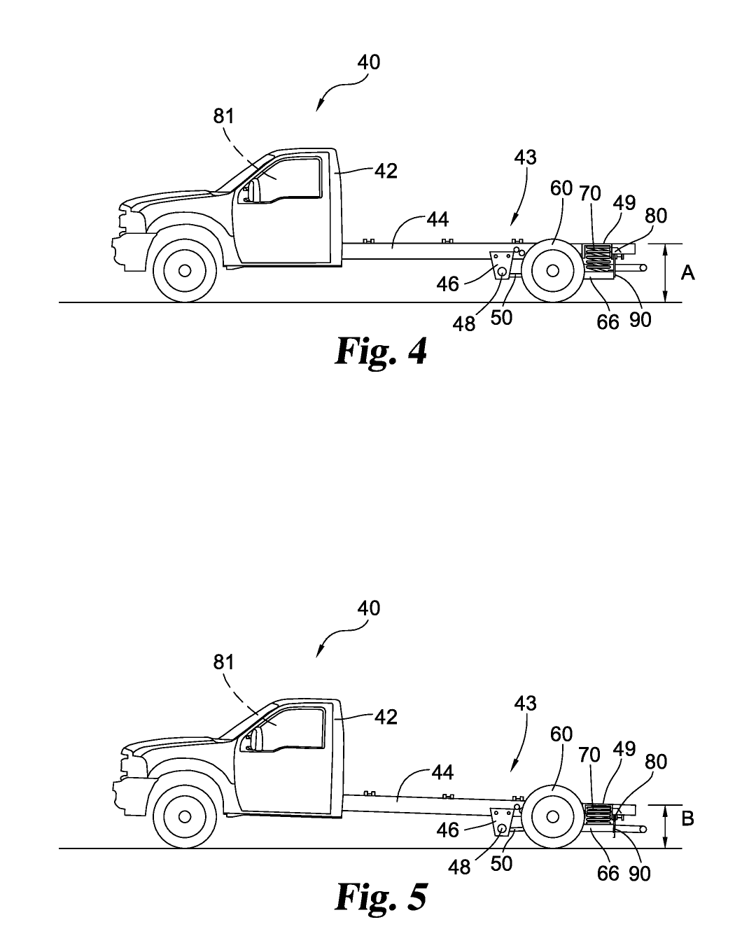

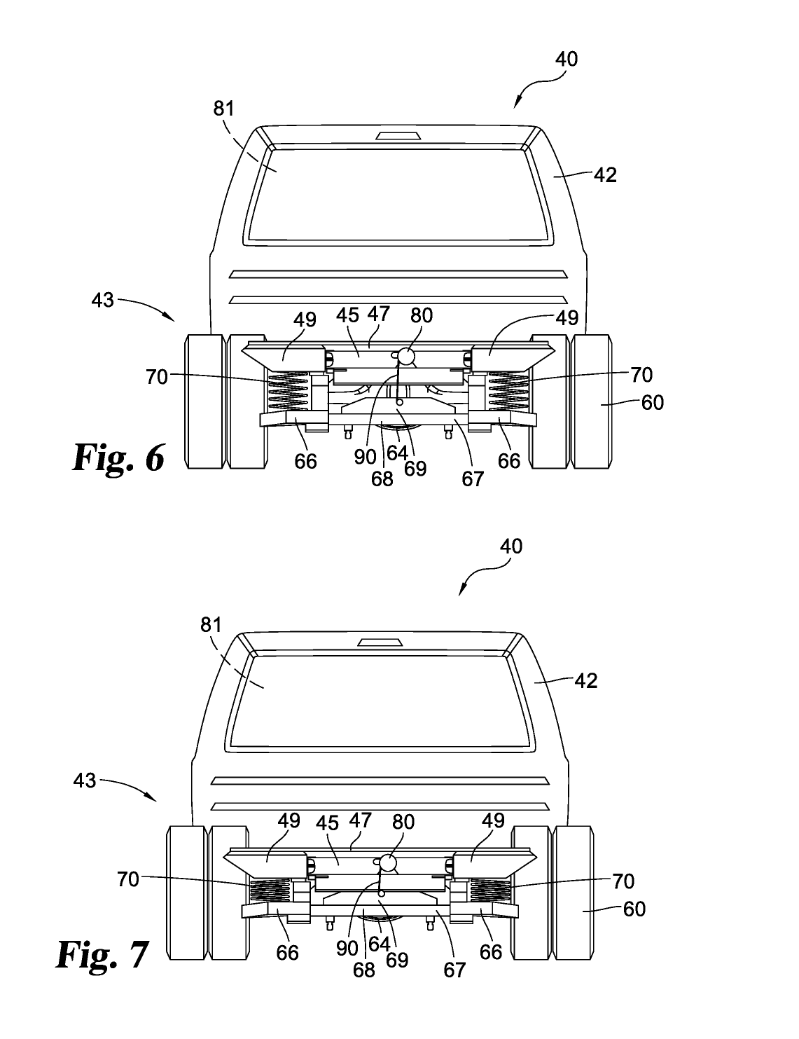

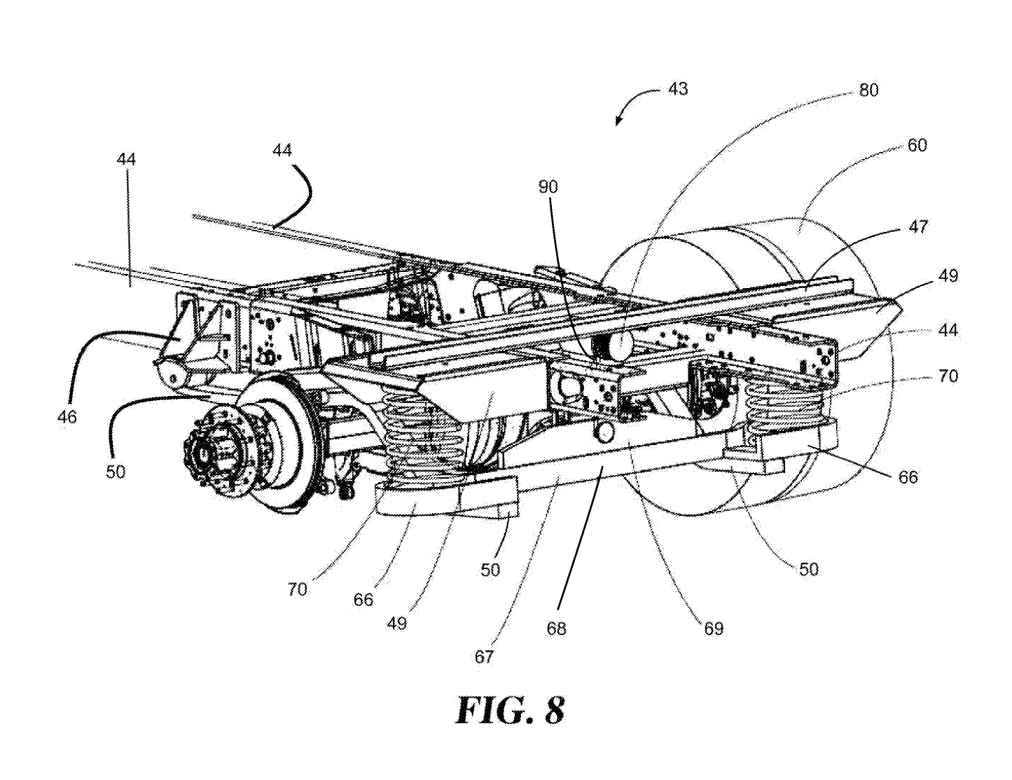

FIGS. 4-8 show vehicle 40 having frame 43 suspended by springs 70 located behind wheels 60 and located outboard the frame rails (as best shown in FIGS. 6 and 7). In this illustrated embodiment, springs 70 are coil springs. Each coil spring 70 is received by an upper mount 49 and a lower mount 66, the lower mount 66 being located on the aft end of a suspension trailing arm 50 that is pivotally coupled by pivot 48 on pivot mount 46 that are coupled to frame rails 44. FIGS. 6, 7, and 8 illustrate upper spring mount 49 coupled to cross member 47 that is in turn coupled to frame rails 44.

Referring to FIG. 8, it can be seen that the bottom ends of coil springs 70 are retained in lower mounts 66 coupled to carrier frame 67. Carrier frame 67 extends laterally across the rear of wheel support 62, and includes central section 68 that includes bracket 69 to which link 90 is coupled. Actuator 80 is coupled to cross member 45.

Link 90 is a flexible connector such as a chain or cable and actuator 80 is a rotary actuator that includes a spool or other structure to receive a length of link 90, effectively varying the distance between actuator 80 and bracket 69. Actuating actuator 80 causes link 90 to either retract or deploy from actuator 80. As shown in FIGS. 5 and 7, actuator 80, upon receiving a command signal, rotates in a direction which retracts link 90 thereby compressing springs 70 and lowering the vehicle's rear load floor represented by the vehicle's frame 43 relative to wheels 60. Actuator controller 81 may optionally be located in cab 42 to permit an operator to control actuator 80 without leaving cab 42.

FIGS. 4 and 6 illustrate frame 43 in a ride height position. Distance A is the distance between the top of frame 43 and the ground in the ride height position. FIGS. 5 and 7 illustrate a lower position where springs 70 are compressed and frame 43 is positioned closer to wheels 60 (and the ground). Distance B is the distance between the top of frame 43 and the ground in the lowered height position. Distance A is greater than distance B.

These figures show link 90 (such as a chain) that is coupled at one end to bracket 69 and at the other end to a sprocket or other link-mounting feature that rotates upon command from actuator 80. FIG. 6 shows actuator 80 in the “unwound” position, such that chain 90 has a maximum length between actuator 80 and bracket 69. In FIG. 7, it can be seen that the link 90 has been wound around the periphery of a sprocket of actuator 80, such that coil springs 70 are compressed, and the top surface of frame 43 has been lowered. In the embodiment illustrated in FIGS. 4-8, actuator 80 is structurally coupled to frame 43 by way of the laterally-extending cross member 47 that couples upper mounts 49 to the frame rails 44.

The embodiment shown in FIGS. 4-8 provides for a vehicle's wide leveraged suspension coil spring. Upper mounts 49 are positioned outside of frame rails 44. The illustrated coil springs are positioned further apart and closer to wheels 60 compared to the position of leaf springs shown in FIGS. 1-3.

With further explanation, FIG. 6 (vehicle at ride height) and FIG. 7 (vehicle at lowered height) are rear elevation views of the vehicle, and corresponding respectively to FIGS. 4 and 5. As can be seen in FIG. 7, when actuator 80 is activated by a signal it retracts or recoils connecting link 90 which is attached to the lower mount 66 by carrier frame 67 and bracket 69. Upon receiving a subsequent command signal the rotary actuator 80 reverses its motion to release coil springs 70 from the lowered height (FIG. 7) back to a ride height (FIG. 6).

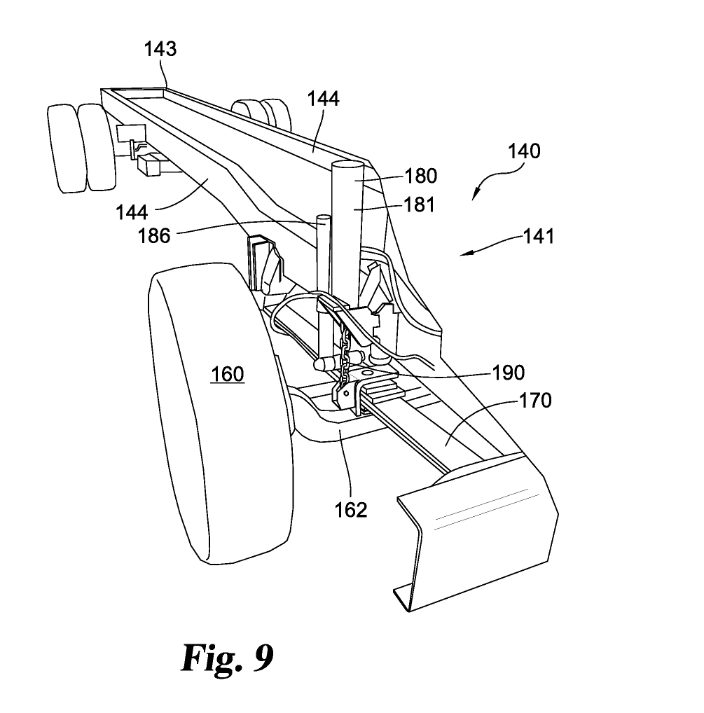

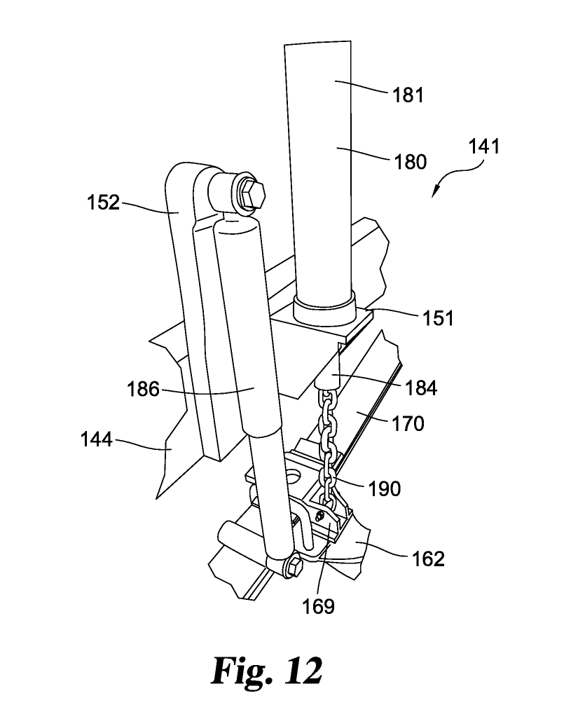

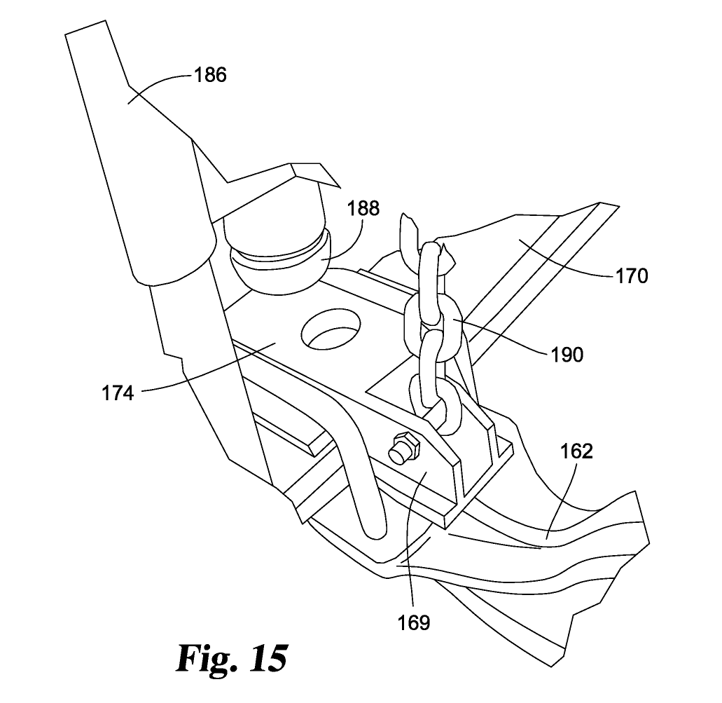

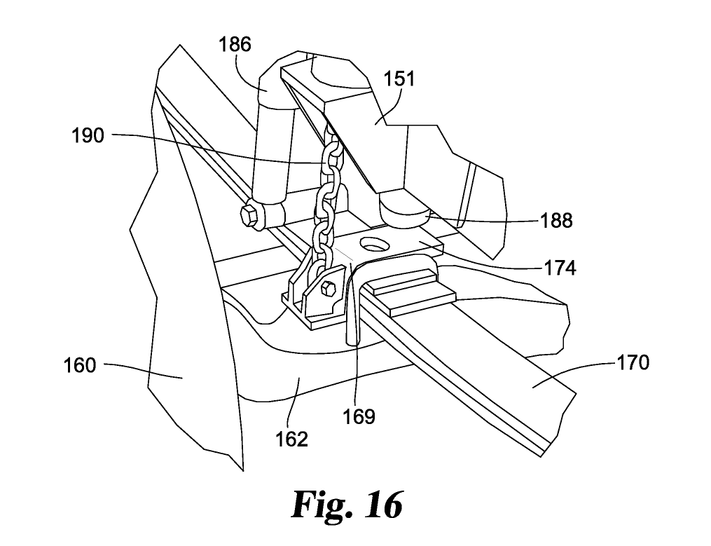

FIGS. 9-16 illustrate kneeling system 141 attached to a front suspension of vehicle 140. FIGS. 9-16 show portions of vehicle 140 incorporating kneeling system 141 on a front wheel. The illustrated kneeling system is for use with vehicle 140 is based on an OEM front leaf spring suspension. However, other embodiments of the disclosed kneeling system could be used, with or without modifications, with other suspension systems including coil spring front suspensions, as well as leaf spring and coil spring rear suspensions.

Vehicle 140 generally includes vehicle frame 143, frame rail 144, wheel support 162, wheel 160, and leaf spring 170. Leaf spring 170 is coupled between frame rail 144 and wheel support 162. Upon the vehicle's wheel 160 jounce and/or rebound action, spring 170 can compress (jounce) or decompress (rebound), e.g., during a vehicle's travel over a bumpy, irregular surfaced road. Spring 170 permits vehicle frame 143 to move relative to wheel support 162 to minimize the movement of vehicle frame 143 when vehicle 140 travels over irregular surfaces.

Kneeling system 141 generally includes upper bracket 151 coupled to frame rail 144, lower bracket 169 coupled to leaf spring 170 and wheel support 162, hydraulic actuator 180 attached to upper bracket 151 and chain link 190 attached to lower bracket 169. In the illustrated embodiment, actuator 180 is a hydraulic cylinder that includes cylinder 181 and rod 184 that is controllably extendable and retractable relative to cylinder 181.

In the illustrated embodiment, vehicle 140 is modified by adding bracketing useful for providing attachment and loading points on vehicle frame 143; attachment and loading points to the wheel support 162, and/or leaf spring 170; and powered actuator 180 adapted and configured to change the spacing between these two attachment points by compression of spring 170.

Referring to FIG. 9, OEM ladder frame 143 is illustrated. Frame 143 extends forward to an engine and transmission, and further to a front suspension modified to include a system for raising and lowering the front of the vehicle relative to the roadway. Frame 143 includes longitudinal frame rails 144.

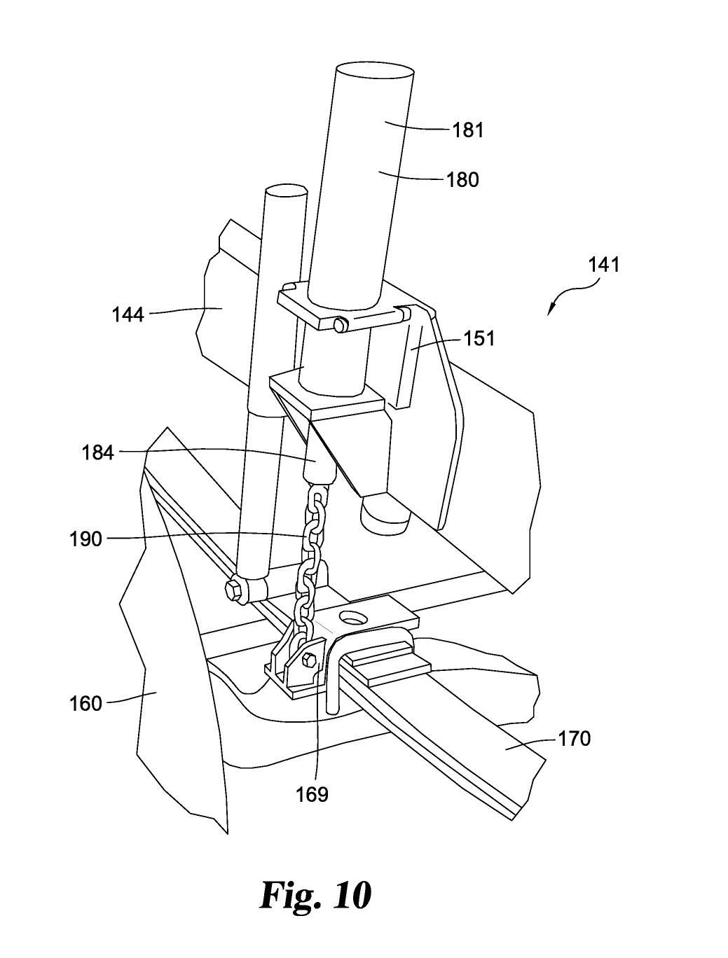

Referring to FIGS. 10-13, vehicle 140 is shown as modified by the addition of kneeling system 141 with the modified front suspension shown in a normal, OEM ride height position. One or more upper brackets 151 firmly couples one component of actuator 180 to frame rail 144. In one embodiment, cylinder 181 of hydraulic actuator 180 is attached to upper bracket 151, although other embodiments are not necessarily so constrained. Yet further embodiments may include powered actuators such as motorized winches and electromagnetic ball screw actuators. With any powered actuator, there are two components that move relative to one another, and the attachment to the frame by way of upper bracket 151 can be to either of these two, relatively-movable components. In the illustrated embodiment, hydraulic actuator 180 includes outer cylinder 181 and rod 184 that is extendable and retractable relative to outer cylinder 181.

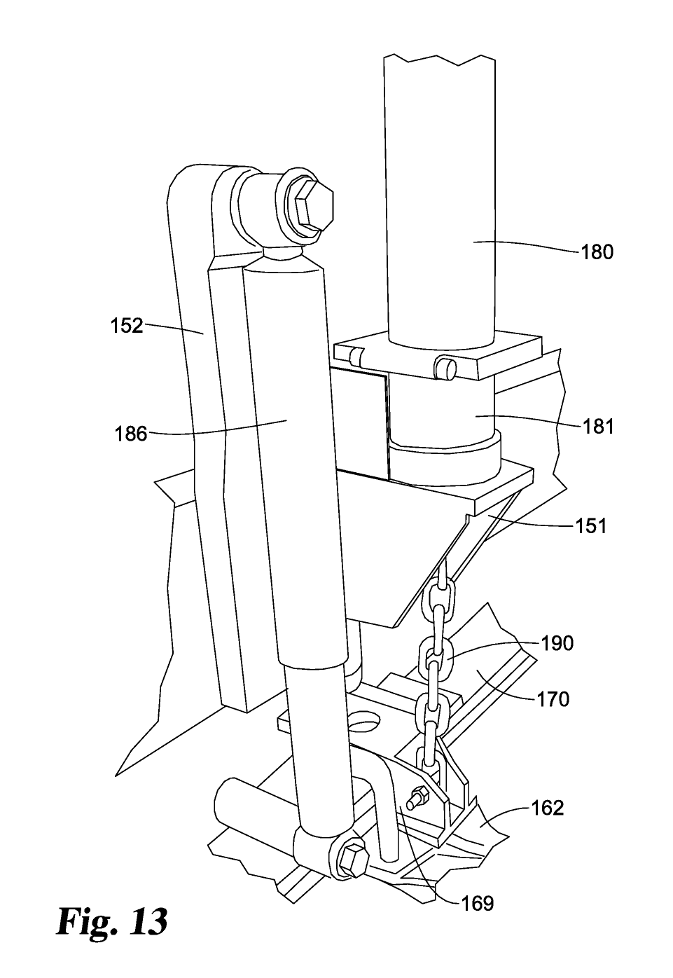

Referring to FIGS. 10 and 13, it can be seen that upper bracket 151 couples outer cylinder 181 to frame rail 144. Rod 184 extends generally vertically from the bottom of outer cylinder 181. Actuator 180 is oriented by vehicle 140 such that rod 184 extends in a generally downward direction and retract in a generally upward direction. The bottom end of rod 184 is coupled to a flexible member, such as a linked chain 190. Still further embodiments contemplate any type of appropriately strong, flexible connection, including other types of chains and cables, as examples.

The bottom end of link 190 is coupled to the front wheel support 162 (and spring 170) by lower bracket 169. In one embodiment, lower bracket 169 includes fore and aft flanges that are sandwiched by fore and aft U-bolts, respectively, to the OEM leaf spring 170 and OEM front wheel support 162. It is understood that in other embodiments, lower bracket 169 can be attached separately to either the leaf spring or the front support. It is further understood that the vehicle 140 can further be used with a modified front leaf spring as shown herein. As best shown in FIGS. 10-12, a nut and bolt can be used to connect link 190 to lower bracket 169.

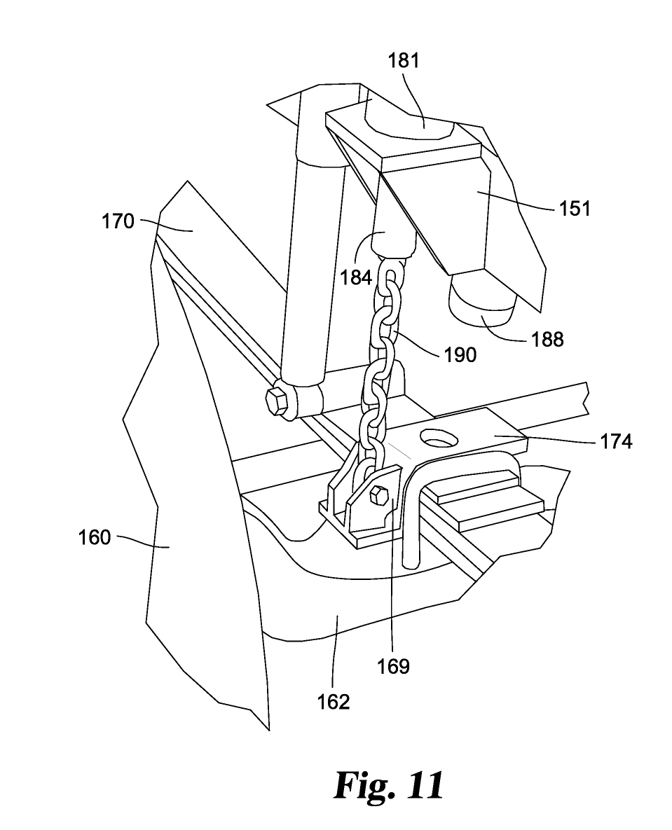

FIGS. 11 and 13 further illustrate shock absorber 186 as part of the front suspension. Upper bracket 152 is bolted to frame rail 144 with one end of shock absorber 186 pivotally attached to upper bracket 152. The other end of shock absorber 186 can be seen pivotally coupled by a bolt to a steel leaf that is sandwiched to leaf spring 170 by way of the fore and aft U-bolts.

Referring to FIG. 11, it can be seen that the front suspension includes a bumper stop 188 that is located generally above a bumper platform 174 of lower bracket 169. FIG. 113 shows the rod 184 of actuator 180 substantially extended out of the actuator cylinder 181. When extended, link 190 is not placed in tension, and preferably includes sufficient slack (i.e., permitting unimpeded movement of the wheel support toward and away from frame 143) to permit OEM amounts of suspension rebound and jounce. However, in yet other embodiments, a low pressure may be applied to the actuator in the direction of retraction. This low pressure would be established so as to simply remove the slack in link 190, but insufficient to interfere with rebound operation of the suspension.

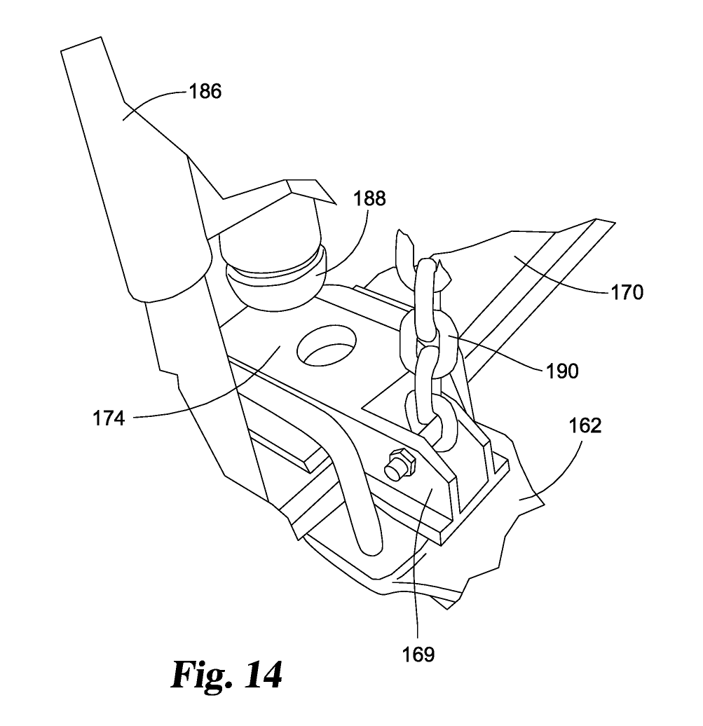

When the operator wants to kneel the chassis to a lowered frame height, such as for loading and unloading, sufficient hydraulic pressure is applied to actuator 180 to result in retraction of rod 184. Rod 184 places tension on link 190 and the actuator 180 pulls frame 143 toward wheel support 162. FIGS. 14-16 show the front suspension at a lowered position with about one inch between the upper face of platform 174 and the contacting face of bumper stop 188. Still further pressure within actuator 180 will result in contact between the opposing faces of the bumper stop and the wheel support contacting surface. When bumper stop 188 abuts platform 174, the lowest possible kneeling position is reached.

Actuator 180 applies tension to link 190 to compress (flatten) leaf spring 170. When hydraulic pressure is released, the biasing force in leaf spring 170 causes it to return to its original curvature, thus pushing frame 143 upward to the OEM ride height position. Hydraulic pressure is not required to restore the lowered frame to the OEM ride height. Instead, the hydraulic pressure that resulted in retraction can simply be dumped to a low pressure reservoir (not illustrated). The rate of release can be controlled by placing an orifice in the reservoir return line. It is also possible to place an electromagnetically operated solenoid valve in either or both of the actuator hydraulic ports to result in a hydraulic locking of the actuator, either at the fully retracted position, or at the fully extended position, as examples.

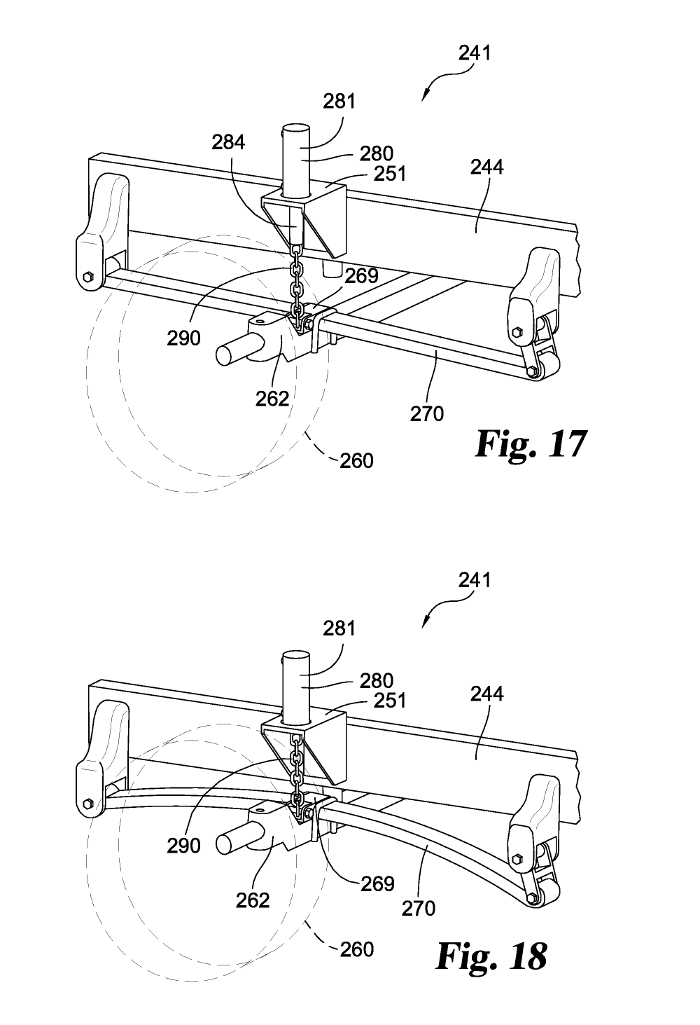

FIGS. 17-18 depict yet another embodiment. Kneeling system 242 is illustrated installed on a portion of an OEM ladder frame chassis having a leaf spring suspension. The base vehicle includes frame rail 244, leaf spring 270, wheel support 262 and wheel 260 (illustrated with dashed lines so as to not obscure other components). Kneeling system 242 generally includes upper bracket 251, lower bracket 269, actuator 280 and link 290. FIG. 17 illustrates the suspension in a partially compressed position while FIG. 18 illustrates the suspension in a lowered position. It will be recognized that the general operation of this modified suspension is similar to that of the embodiment shown in FIGS. 9-17 above.

The suspension includes upper bracket 251 that couples one relatively movable component of an actuator 280 to longitudinal rail 244 of an OEM ladder frame. The other relatively movable component is coupled to lower bracket 269 that couples leaf spring 270 and wheel support 262 to flexible member 290. FIG. 17 shows the suspension with rod 284 of actuator 280 partially retracted into cylinder 281 resulting in partial compression on leaf spring 270. When rod 284 is fully extended form actuator 280 (not shown), the suspended wheel is free to move in both jounce and rebound with OEM-designed characteristics such as travel and rate of travel. In the fully extended state (i.e., permitting unimpeded movement of the wheel support toward the frame, as shown), there is sufficient slack in flexible member 290 to permit rebound. For purposes of rebound, the flexible nature of the link (being unable to provide compression from lower bracket 269 into rod 284 or actuator 280) accommodates the OEM-designed rebound travel limits. Preferably, rod 284 of actuator 280 is located so as to not interfere with operation of jounce.

FIG. 18 shows the suspension in the lowered position, such that rod 284 of actuator 280 is fully retracted upward into cylinder 281. This application of force by actuator 280 results in the actuator pulling frame rail 244 downward (through a load path including bracket 251), and substantially reducing the distance between leaf spring 270 and frame rail 244. As with the suspension modified by kneeling system 141, a suspension modified with kneeling system 241 returns to its normal, OEM ride height by simply removing the retraction pressure from actuator 280.

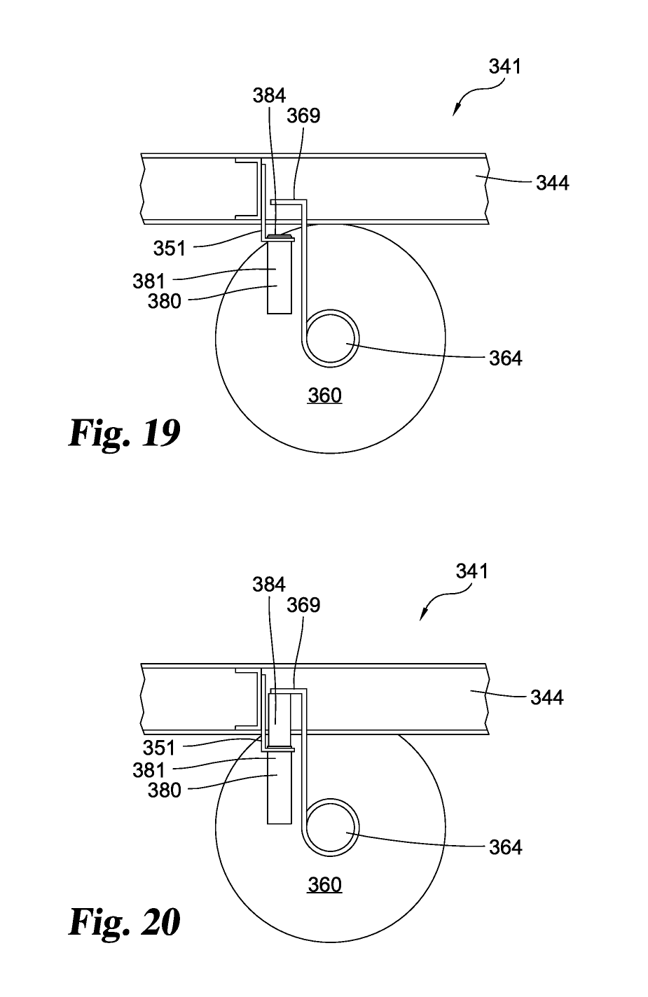

FIGS. 19 and 20 schematically represent a kneeling system 341 adapted and configured to provide a chassis that can be placed at the normal, OEM ride height, and also at a lowered position. What will be shown and described is with reference to a rear axle, but it is understood that the methods and apparatus shown and described are further adaptable and configurable to a front suspension. Further,

FIGS. 19 and 20 do not show a suspension spring for purposes of clarity, but it is understood that any type of spring (leaf, coil, torsion) can be used with this and other embodiments.

The rear suspension shown in FIGS. 19 and 20 incorporates a vertically-directed, powered actuator 380 that is coupled by bracket 351 to frame rail 244. As illustrated, actuator 380 is coupled by bracket 351 to frame rail 244 such that cylinder 381 (i.e., the portion of the actuator that is static relative to the frame) is located on the bottom, with rod 384 projecting vertically upward. As shown in these figures, actuator 380 is a hydraulic actuator with cylinder 381 coupled to the lower leg of L-shaped bracket 351, with the rod 384 extendable in an upward position.

Kneeling system 341 further includes axle bracket 369 coupled to axle housing 364. In the illustrated embodiment, axle bracket 369 has an inverted L-shape, with the long leg of the L incorporating structures for attaching and stabilizing the bracket relative to the axle (not illustrated). In one embodiment, (not illustrated) axle bracket 369 includes a two-piece, clampable bracket, with two halves that bolt together and lock on to axle housing 364. Still further, the axle bracket 369 may incorporate one or more struts that couple the bracket assembly to another location (such as a shock absorber mount) to permit the bracket to resist relative rotation on the axle.

Referring to FIG. 19, it can be seen that the short leg of the L-shaped axle bracket 369 extends over and above the end of rod 384 when the chassis is at a ride height. Preferably, there is a gap between the opposing faces of the short leg of bracket 369 and the top contacting surface of rod 384. This gap is established as a distance that permits free jounce of the suspension when it strikes a pothole in the roadway. Therefore, when the powered actuator 380 is fully retracted, kneeling system 341 permits normal, OEM operation of the suspension.

When the operator of the vehicle wants to place the vehicle at a lowered height, the actuator is powered a short distance until rod 384 contacts bracket 369. FIG. 20 shows the hydraulic cylinder 380 in an extended state, such that the end, contacting surface of the rod 384 is in abutting relationship with the short leg of the L-shaped bracket 369. The gap between rod 384 and bracket 369 shown in FIG. 19 represents a short, dead zone in which the actuator is free to move, but there is no compression of the vehicle suspension. After rod 384 contacts the lower face of bracket 369, the continued actuation and extension of the actuator results in a static relationship between the end of rod 384 and bracket 369, with the cylinder 380 of the actuator pulling frame rail 344 down and compressing the suspension through the load path of bracket 351. Note that the bottom of the cylinder 381 is moved to a lower position, closer to a roadway. However, actuator size and power requirements (whether electrical, hydraulic, or pneumatic) may be adapted and configured such that the lowest point of the actuator maintains a comfortable distance above a roadway (as shown in FIG. 20, extending about down to the centerline of the rear axle).

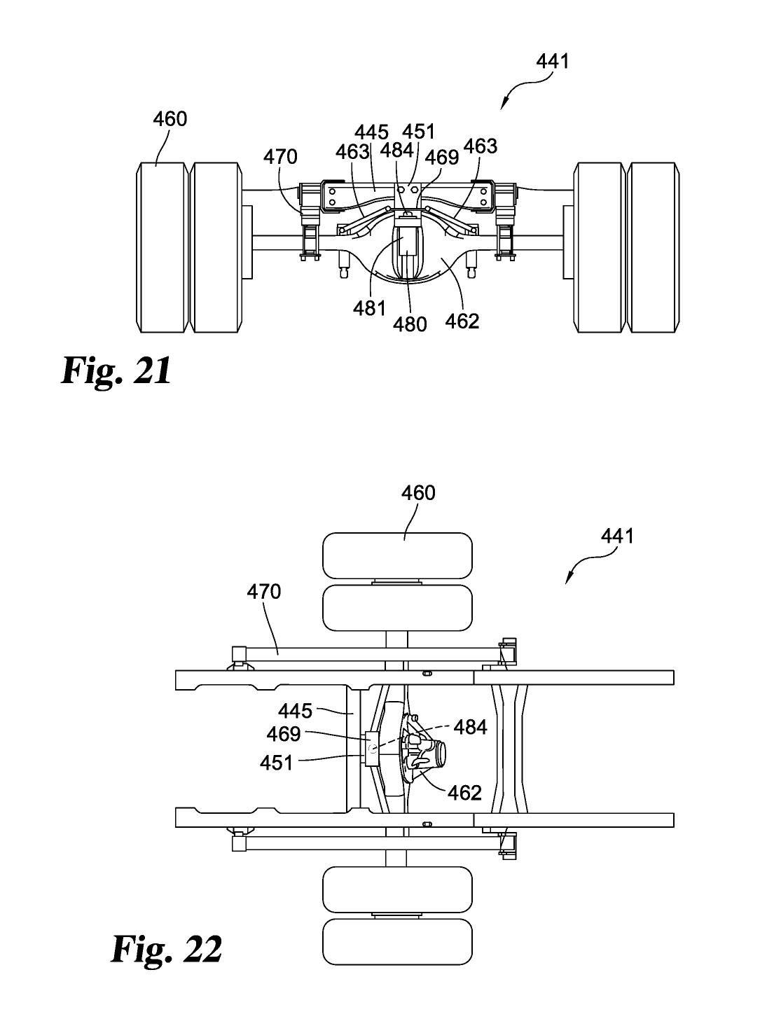

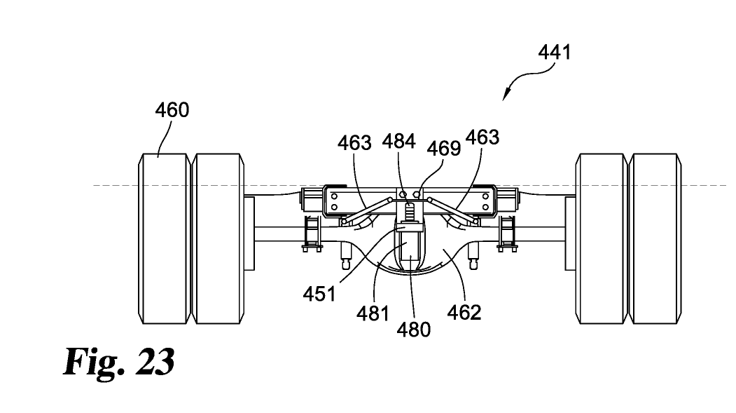

FIGS. 21-23 present several views of a schematic representation of kneeling system 441 that provides for a single actuator to place an axle at a lowered height for loading and unloading. Although what will be shown and described is for use on a rear axle, it is understood that the system can be adapted and configured to apply a single, central load to a front axle, and likewise reduce the height of the front of the vehicle from the normal, OEM ride height to a lowered position. FIGS. 21 and 22 illustrate a ride height position while FIG. 23 illustrates a lowered, “kneeled,” position. Kneeling system 441 generally includes actuator 480, bracket 451, bracket 469 and links 463.

FIG. 21 is an end elevational view of kneeling system 441 installed on an OEM ladder frame vehicle. L-shaped bracket 451 is secured by bolts to frame cross member 445. This bracket is located generally centrally above the differential case of a driven rear axle. However, it is also understood that the system shown and described is further applicable to non-powered through axles.

Powered actuator 480 is attached to a bottom leg of an L-shaped bracket 451, in a manner similar to that shown for kneeling system 341. Actuator 480 is oriented with rod 484 projecting upward and cylinder 481 positioned below the bottom leg of bracket 451. As shown in FIGS. 21 and 22, bracket 469 and a pair of links 463 are attached at outboard ends of axle case 462, and at their inboard ends to bracket 469. This loading platform is located generally above, and separated by a gap from, the upper end of rod 484. Referring briefly to FIG. 22, the end of rod 481 is shown as a dashed circle for purposes of clarity (in this top view, the end of the actuator is hidden by bracket 469).

In one embodiment, the two links 463 and bracket 469 are pivotally connected both to one another, and further to axle housing 462. Yet other embodiments contemplate assemblies of links 463 and bracket 469 that function as unitary assemblies, even if welded or bolted together. In the embodiment shown in

FIG. 21, the pivot axes are generally arranged longitudinally, and permit one dimensional pivoting. However, yet other embodiments incorporate yet other kinds of pivot joints, including two dimensional joints such as ball joints. The pivoting features of bracket 469 may permit improved distribution of loads when actuator 480 is actuated to lower cross frame member 445 as shown in FIG. 23.

Preferably, the free, uppermost contact surface of rod 484 is smooth and semi-spherical to account for possible misalignments during actuation. Still further, the contact surface of bracket 469 can include a low friction surface, such as an HDPE rub block, to improve the ease of actuation of actuator 480.

FIG. 23 shows the suspension actuated to a lowered position. Rod 484 of powered actuator 480 is extended through a first, dead zone gap until the end of rod 484 abuts the contact surface of bracket 469. Once contact is established, further powering of actuator 480 results in rod 484 pushing against bracket 469 (which remains static, except for slight pivoting or sliding motion), and thereafter rod 484 pushes frame 445 to the lowered position by way of bracket 451.

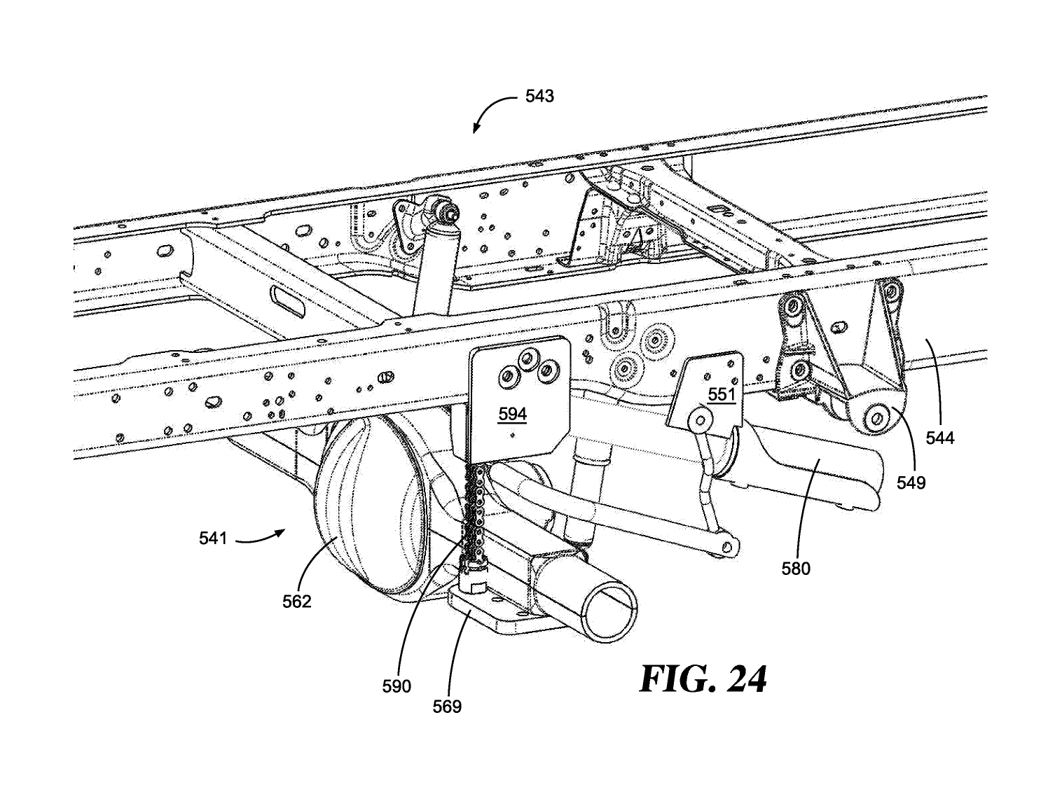

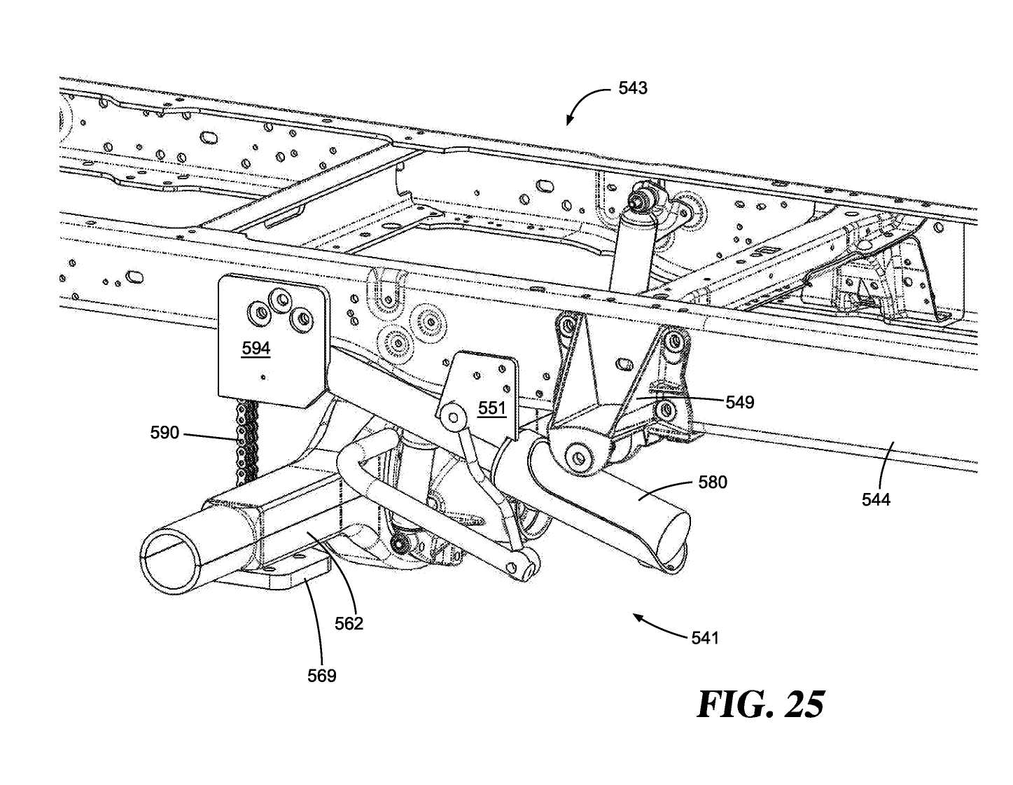

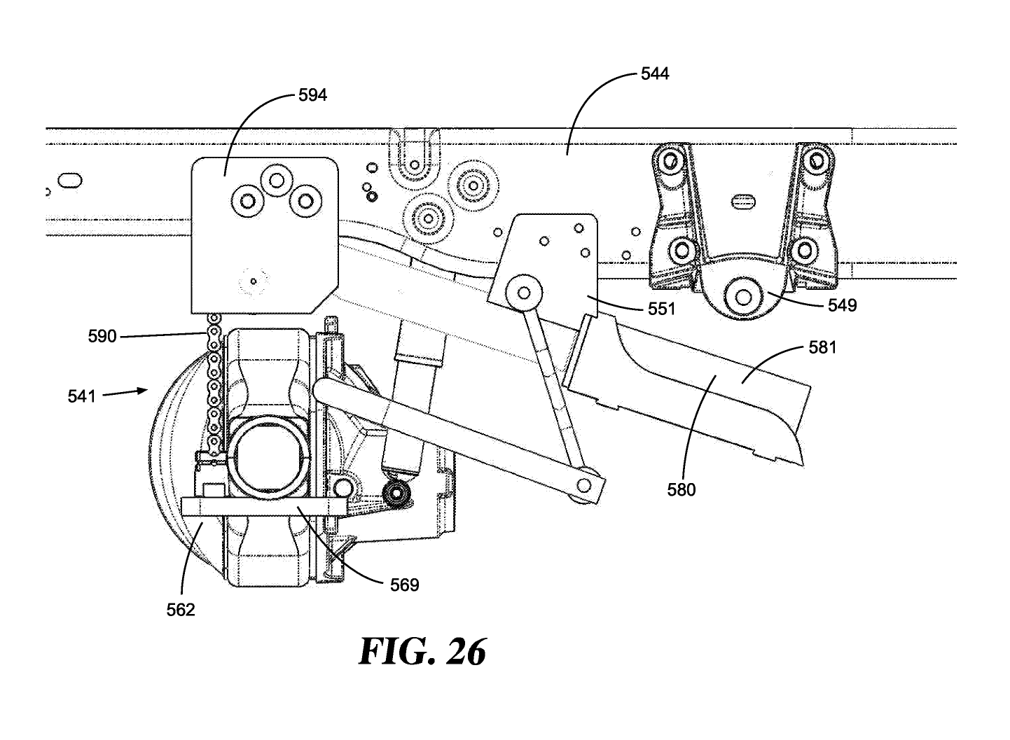

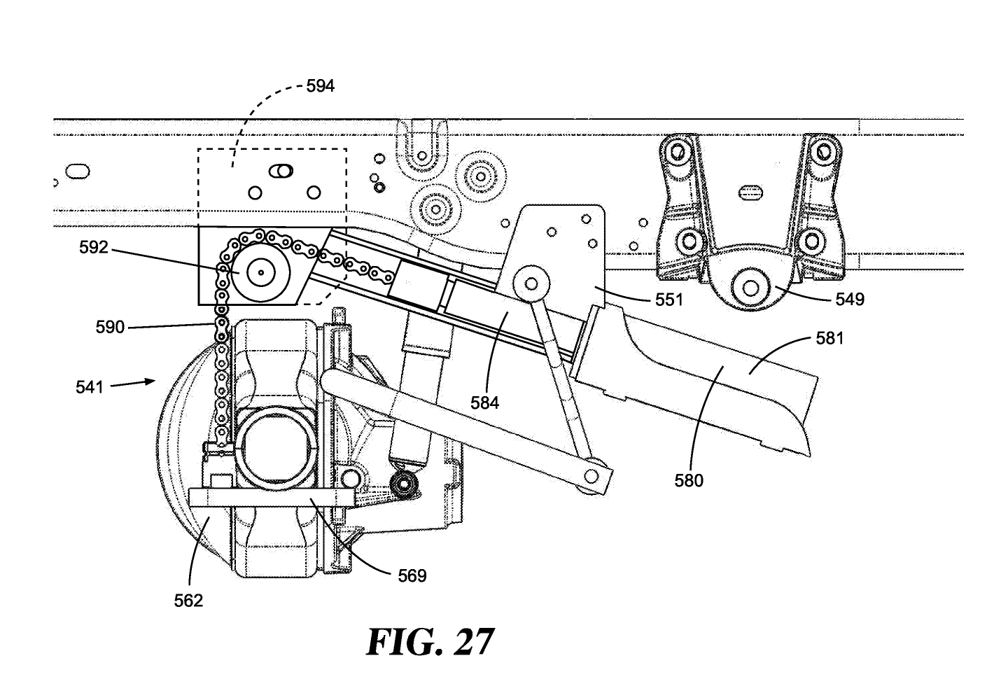

FIGS. 24-28 illustrate kneeling system 541 attached to a vehicle that includes frame 543 and wheel support 562. While not illustrated for clarity, it should be understood that the illustrated vehicle includes a suspension system coupling wheel support 562 and rail 543. In this regard, one upper mount 549 for coupling one end of a leaf spring is shown in FIGS. 24-28 attached to frame rail 544 of frame 543. Kneeling system 541 generally includes actuator 580 and link 590. FIGS. 26 and 27 show the same view, but FIG. 27 includes selected cross-section views of certain components that are not otherwise visible in FIG. 26. FIGS. 24-27 show kneeling system 541 in a ride height configuration. A lowered position is not illustrated.

Actuator 580 is coupled to frame rail 544 of frame 543 by upper bracket 551. Actuator 580 is a linear actuator such as a hydraulic cylinder and includes rod 584 that is selectively extendable and retractable from cylinder 581. The end of rod 584 is coupled directly to flexible link 590. Flexible link 590 is coupled to wheel support 562 at lower bracket 569. Flexible link 590 extends across sprocket 592. Sprocket 592 is coupled to frame rail 544 by bracket 594.

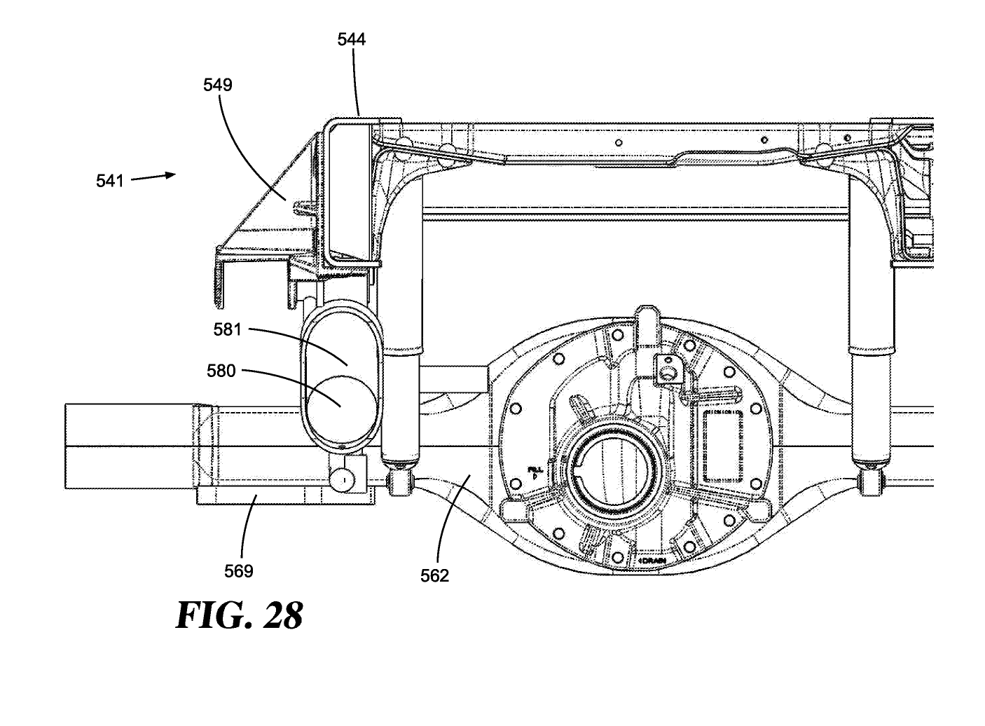

As best seen in FIG. 28, kneeling system 541 is largely positioned below frame rail 544 and inboard of upper mount 549 for the leaf spring. As best seen in FIG. 26, kneeling system 541 is positioned inside upper mounts 549 (a second upper mount 549 for the leaf spring is attached to frame rail 544 on the opposite side of wheel support 562). OEM frames are often reinforced between the mounting locations for the leaf spring (as this is the primary location where loads are applied to the frame. Attaching kneeling system 541 to the reinforced portion of frame rail 544 may reduce the need to add additional reinforcing structure to transfer the loads applied when kneeling system 541 is actuated. Kneeling system 541 is configured to add to OEM frames and suspensions without significantly reconfiguring or reinforcing the OEM frame and suspension. The illustrated configuration also minimizes any lateral displacement between forces generated by link 590 on frame rail 544 and forces transferred to frame rail 544 through a leaf spring attached to upper mount 549.

As shown, the axis of actuator 580 is not aligned with a vertical axis. Sprocket 592 operates to redirect force applied by actuator 580 to link 590 to a generally vertical direction to move wheel support 562 generally vertically relative to frame 543. Movement of rod 584 relative to cylinder 581 moves link 590 relative to sprocket 592 and causes sprocket 592 to rotate and move with link 590, thereby moving lower bracket 569 and wheel support 562 generally vertically relative to frame rail 544 (thereby compressing the suspension system as rod 584 is retracted into cylinder 561).

Positioning the axis of actuator 580 in a non-vertical orientation may permit installation on vehicles where there may be insufficient space for a vertically oriented actuator as disclosed in other embodiments above. Such a configuration may facilitate the use of single-state actuators rather than multi-stage actuators that might be required in other installations.

Link 590 may optionally include a slack length sufficient for wheel support 562 to move away from frame rail 544 a rebound distance allowable by the suspension system used to support frame 543 over wheel support 562, such that kneeling system 541 does not change the characteristics of the suspension system when actuator 580 is not actuated.

The embodiments depicted in FIGS. 9, 17, 19 and 24 include a powered actuator located proximate to a wheel. Operation of that actuator results in movement of the suspension of the corresponding wheel. It is envisioned that the embodiments shown herein can be applied to a single wheel, to a pair of front wheels, to a pair of rear wheels, to the pair of left side wheels, to the pair of right side wheels, or to all four wheels. Still further, the various embodiments shown herein can be adapted and configured such that a single actuator permits multiple-height operation of a pair of front wheels, or a pair of rear wheels, as will now be described.

FIGS. 9-28 depict structures for actuated kneeling of a vehicle suspension between a normal ride height and lowered, kneeled, position, including embodiments in which the actuation system includes a predetermined dead zone of travel. In this dead zone, movement of the actuator does not result in compression or decompression of the suspension spring. The dimensional size of this dead zone may be adapted and configured to permit substantially unimpeded rebound or jounce, depending upon how the powered actuator achieves compression of the spring. As examples, the suspension systems of FIGS. 9, 17 and 24 include a jounce dead zone. Referring to FIG. 17, with the chassis at the OEM ride height, the upward movement of the frame relative to the frame is largely unimpeded by the actuator. In the embodiments shown in FIGS. 9, 17 and 24, the actuator is coupled to the wheel support by a flexible link that is largely unable to provide an upward compression force.

Referring to the embodiments shown in FIGS. 19 and 21, it can be seen that downward movement of the frame is largely unimpeded by the actuator. In these embodiments, a fully retracted actuator is spaced apart by the corresponding actuation surface by a gap. This gap is adapted and configured to provide an OEM amount of rebound travel.

The systems depicted in FIGS. 9, 17 and 24 include a flexible link couples the wheel support to the actuator, and relative movement is achieved by retraction of the actuator and placing the flexible link in tension. However, yet other variations are contemplated. For example, it would be possible to modify the suspension of FIG. 17 by wrapping a flexible link partly around a pulley adjacent to the actuator, and thereby changing the direction of action of the flexible link. With such a modification, extension of the actuator would place the flexible link in tension. As yet another example, the present disclosure further contemplates a modification of the embodiment shown in FIG. 19. In this modification, the actuator orientation is moved such that the actuator is above the short leg of the L-shaped axle bracket. With this actuator at an extended position when the vehicle is at the OEM ride height, the retraction of the actuator would result in compression of the suspension spring and movement of the chassis to the lowered height.

Still further, what has been shown and described are suspension systems in which there is a dead zone of travel through which the actuator travels prior to compression of the suspension spring. In embodiments such as the ones represented in FIGS. 9, 17 and 24, it is understood that the dead zone of movement can be accomplished by using a length of a flexible member (such as a chain, cable, or other) that is longer than the distance between the end of the extended actuator and attachment point to the wheel support. However, in some embodiments to prevent unnecessary noise from an over-long length of a flexible member, it would further be possible to provide a small retractive force on the actuator to take up this slack length, and the actuation force could be small enough so that it eliminates the slack, yet does not substantially compress the suspension spring.

In one embodiment, there is a method for raising and lowering a motor vehicle that includes means for limiting travel of a powered actuator that is operable to travel between a first travel limit and a second travel limit. It is understood that the travel limit could be established by a hard stop within the actuator (such as a pair of pegs that place limits on the rotational movement of a pulley or winch, or hard stops that can be encountered between a piston/rod and a cylinder), could be achieved electronically (such as with an electronic controller that uses a position signal corresponding to the movement of the actuator), or by other methods. Intermediate of the two travel stops is a third position. The travel distance from one of the stops to the third position establishes the actuation dead zone discussed above. Continued powering of the actuator past this third, intermediate position results in continuing compression of the spring until the travel limit is reached. Likewise, removing power from the actuator (or otherwise unlocking the actuator) permits the stored energy of the compressed spring to move the actuator back toward the third intermediate position. Once it reaches this position, and further as it travels to the other travel stop, the chassis is once again placed at the OEM ride height.

Any theory, mechanism of operation, proof, or finding stated herein is meant to further enhance understanding of the disclosed occlusion device, and is not intended to limit the claimed invention in any way to such theory, mechanism of operation, proof, or finding. While the claimed invention has been illustrated and described in detail in the drawings and foregoing description, the same is to be considered as illustrative and not restrictive in character, it being understood that only selected embodiments have been shown and described and that all equivalents, changes, and modifications that come within the spirit of the disclosed shackles as defined herein or by the following claims are desired to be protected.

We claim:

1. A vehicle comprising:
a vehicle frame;
a wheel support;
a wheel coupled to the wheel support;
a suspension operatively coupling the vehicle frame to the wheel support,
wherein the suspension permits the vehicle frame to move relative to the wheel support; and
a powered actuator that is selectively movable between a first condition and a second condition, wherein, in the first condition, the powered actuator does not restrict movement of the vehicle frame relative to the wheel support and in the second condition, the powered actuator compresses the suspension thereby restricting movement of the vehicle frame relative to the wheel support and bringing the vehicle frame closer to the wheel support.

2. The vehicle of claim 1, wherein the second condition approximates a minimum distance between the vehicle frame and the wheel support permitted by the suspension.

3. The vehicle of claim 1, wherein the suspension is adapted to permit the vehicle frame to move relative to the wheel support between a maximum jounce condition and a maximum rebound condition and wherein, when the powered actuator is in the first condition, the vehicle frame is moveable relative to the wheel support between the maximum jounce condition and the maximum rebound condition.

4. The vehicle of claim 1, wherein the suspension comprises a spring that exerts a biasing force between the wheel support and the vehicle frame.

5. The vehicle of claim 4, wherein the powered actuator applies a compressing force between the vehicle frame and wheel support that is greater than the biasing force of the spring.

6. The vehicle of claim 5, wherein, when moving the powered actuator between the first condition and the second condition, there is a dead zone through which the powered actuator travels before the compressive force is applied to the spring.

7. The vehicle of claim 1, wherein the powered actuator is a hydraulic cylinder.

8. The vehicle of claim 1, further comprising a link operationally coupled to the powered actuator, wherein the link and powered actuator are operatively coupled between the vehicle frame and the wheel support and wherein, in the first condition, the powered actuator and link do not restrict movement of the vehicle frame relative to the wheel support and in the second condition, the powered actuator and link compress the suspension thereby restricting movement of the vehicle frame relative to the wheel support and bringing the vehicle frame closer to the wheel support.

9. The vehicle of claim 8, wherein the link is a chain.

10. The vehicle of claim 9, further comprising a sprocket that cooperates with the chain to change the direction of a force applied to the chain by the powered actuator. The vehicle of claim 8, wherein the powered actuator is physically coupled to one of the vehicle frame or the wheel support and wherein the link is physically coupled to the other of the vehicle frame or the wheel support.

12. The vehicle of claim 8, further comprising a gear that cooperates with the link to change the direction of a force applied to the link by the powered actuator.

13. The vehicle of claim 12, wherein the gear and the powered actuator are physically coupled to the vehicle frame and the link is physically coupled to the wheel support.

14. The vehicle of claim 13, wherein the vehicle frame includes a frame rail and wherein the gear and the powered actuator are coupled underneath a portion of the frame rail that the suspension is coupled to.

15. The vehicle of claim 8, wherein, when actuating the powered actuator between the first condition and the second condition, there is a dead zone through which the powered actuator and the link travel before the compressive force is applied to the spring.

16. The vehicle of claim 1, further comprising a vehicle cab and a control located in the vehicle cab, wherein the control is operationally coupled to the actuator to control movement of the actuator between the first and second conditions.

17. The vehicle of claim 1, further comprising a bracket attached to one of the vehicle frame or the wheel support, wherein the actuator is attached to the other of the vehicle frame or the wheel support and wherein the bracket is positioned relative to the actuator so that actuation of the actuator applies force to the bracket that moves the wheel support and vehicle frame closer together.

18. The vehicle of claim 17, wherein, when the actuator is not actuated, there is a gap between the bracket and the actuator.

19. The vehicle of claim 17, wherein the actuator is a hydraulic cylinder having a rod.

20. The vehicle of claim 19, wherein the hydraulic cylinder is attached to the vehicle frame in a vertical orientation.
